(19) United States
(12) Patent Application Publication
(10) Pub. No.: US 2005/0268446 A1
(43) Pub. Date: Dec. 8, 2005

(54) Fixture assembly for milling and drilling on woodwork

(76) Inventors: Ming-Hsiang Chiu, Taichung (TW); Hsu Hsiu-Kwei Liu, Taichung (TW)

Correspondence Address: TROXELL LAW OFFICE PLLC, SUITE 1404, 5205 LEESBURG PIKE, FALLS CHURCH, VA, 22041, US

(21) Appl. No.: 10/860,055

(22) Filed: Jun. 4, 2004

(51) Int. Cl. B23P 23/00

(52) U.S. Cl. 29/26 A; 144/1.1

(57) ABSTRACT

A fixture assembly includes a plurality of base frames, clamping devices, adjusting plates, connecting brackets, inserting plates, and drill-locating seats that can be differently and actively connected with one another to allow precise drilling and milling on a workpiece. The fixture assembly is firmly fixed to two lateral sides of the workpiece using the clamping devices, so that a milling machine may be stably moved along a top of the base frames to mill desired grooves or slots on the workpiece. The fixture assembly also enables precise drilling simply by aligning a drilling machine with the drill-locating seat that has been adjusted to a desired position for drilling on the workpiece.

### FIELD OF THE INVENTION

The present invention relates to a fixture assembly for milling and drilling on woodwork, and more particularly to a fixture assembly including a plurality of base frames, clamping devices, adjusting plates, connecting brackets, inserting plates, and drill-locating seats that can be differently and actively connected with one another to allow efficient and precise drilling and milling on a workpiece.

### BACKGROUND OF THE INVENTION

Specific fixtures are required in woodwork to firmly clamp a workpiece in place, so that accurate, quick, and convenient drilling and groove-milling works may be performed on the workpiece at desired positions. FIG. 1 shows a conventional fixture A designed only for drilling holes on woodworks, and FIG. 2 shows another conventional fixture B designed only for milling grooves or slots on woodworks. The fixtures A and B respectively have only one single function, that is, drilling or milling, and none of them could be used to perform drilling and milling at the same time. Moreover, the fixture B does not provide flush planes around it for a milling machine C to bear against when the milling machine C is moved. Therefore, grooves or slots milled by the milling machine C fail to have a uniform depth. The fixture B does not include any scale or graduations to cause inconvenience in adjusting the sizes of grooves and slots to be milled. Further, both the conventional fixtures A and B have complicate structures and large volumes and are therefore not convenient for use.

It is therefore tried by the inventor to develop a compact multifunctional fixture assembly that is practical and convenient for use by consumers.

### SUMMARY OF THE INVENTION

A primary object of the present invention is to provide a fixture assembly that may be conveniently used to perform both milling and drilling on woodwork. To achieve this object, the fixture assembly includes plurality of base frames, clamping devices, adjusting plates, connecting brackets, inserting plates, and drill-locating seats that can be differently and actively connected with one another to allow efficient and precise drilling and milling on a workpiece at the same time.

Another object of the present invention is to provide a fixture assembly that provides flush surfaces on the top of assembled base frames and other components, and therefore allows a milling machine to stably and smoothly move on the base frames of the fixture assembly.

A further object of the present invention is to provide a fixture assembly having scales fitted thereto to enable precise milling and drilling on a workpiece.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIGS. 1 and 2 show conventional drilling and milling fixtures, respectively, for woodworking;

FIG. 3 is an exploded perspective view of a fixture assembly for milling and drilling on woodwork according to the present invention;

FIG. 4 shows the relation between base frames and connecting brackets and inserting plates included in the fixture assembly of the present invention;

FIG. 5 is an exploded perspective view showing the structural relation between a base frame and a clamping device included in the fixture assembly of the present invention;

FIG. 6 is similar to FIG. 5 with a middle adjusting part of the clamping device in an assembled state;

FIG. 7 is a partially assembled perspective view of FIG. 3 with the clamping devices connected to a lower side of the base frames;

FIG. 8 is an enlarged perspective view showing the connection of the clamping device to a base frame included in the fixture assembly of the present invention;

FIG. 9 shows the use of the fixture assembly of the present invention to drill a hole on a workpiece; and

FIGS. 10 and 11 shows the use of the fixture assembly of the present invention to mill a groove or recess on a workpiece.

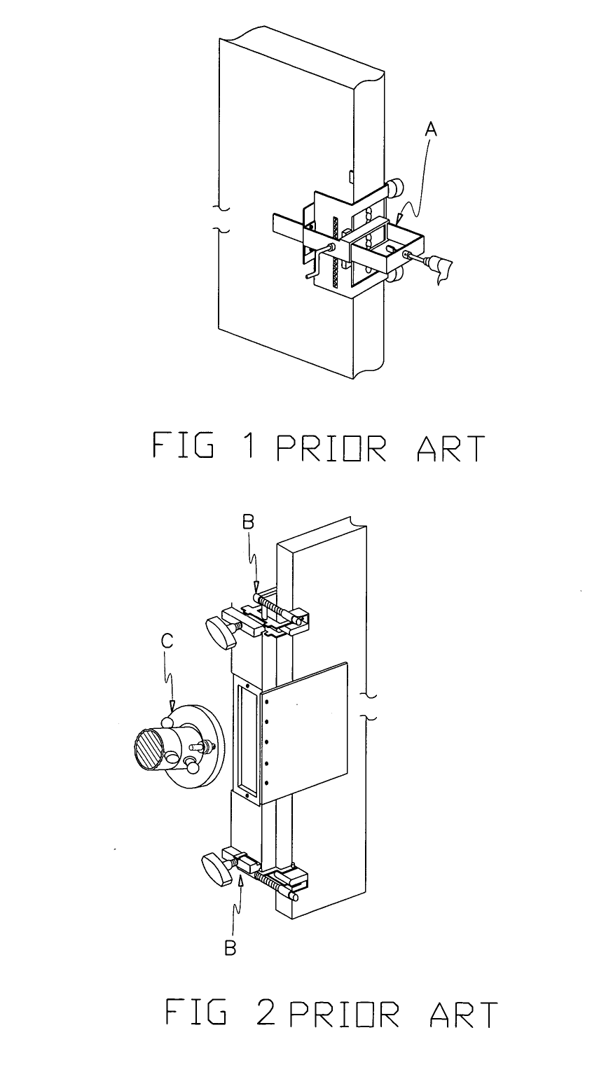

### DETAILED DESCRIPTION OF THE PREFERRED EMBODIMENTS

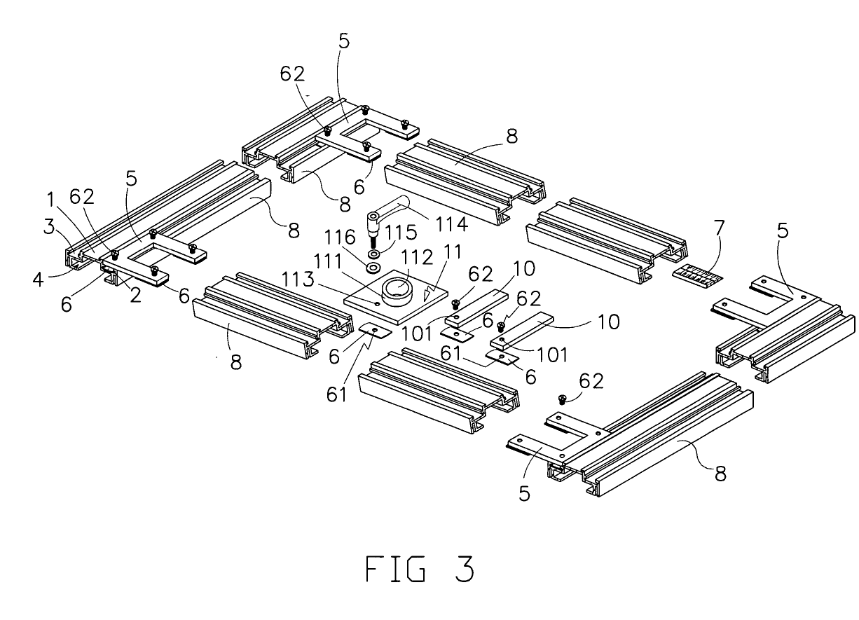

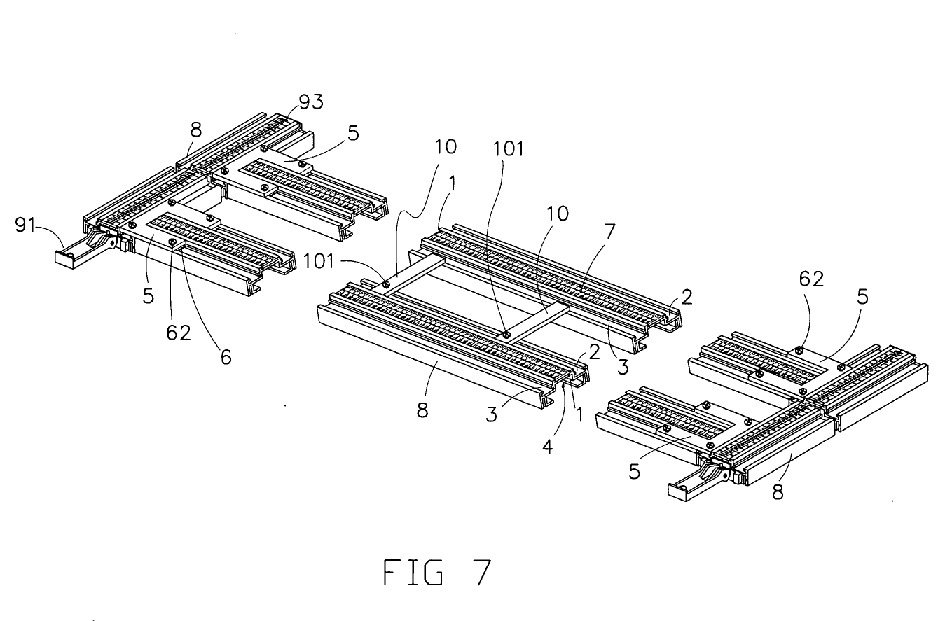

Please refer to FIG. 3 that is an exploded perspective view of a fixture assembly for milling and drilling on woodwork according to the present invention. As shown, the fixture assembly of the present invention mainly includes a plurality of base frames 8, clamping devices 9 (see FIG. 7), adjusting plates 10, connecting brackets 5, inserting plates 6, and drill-locating seats 11.

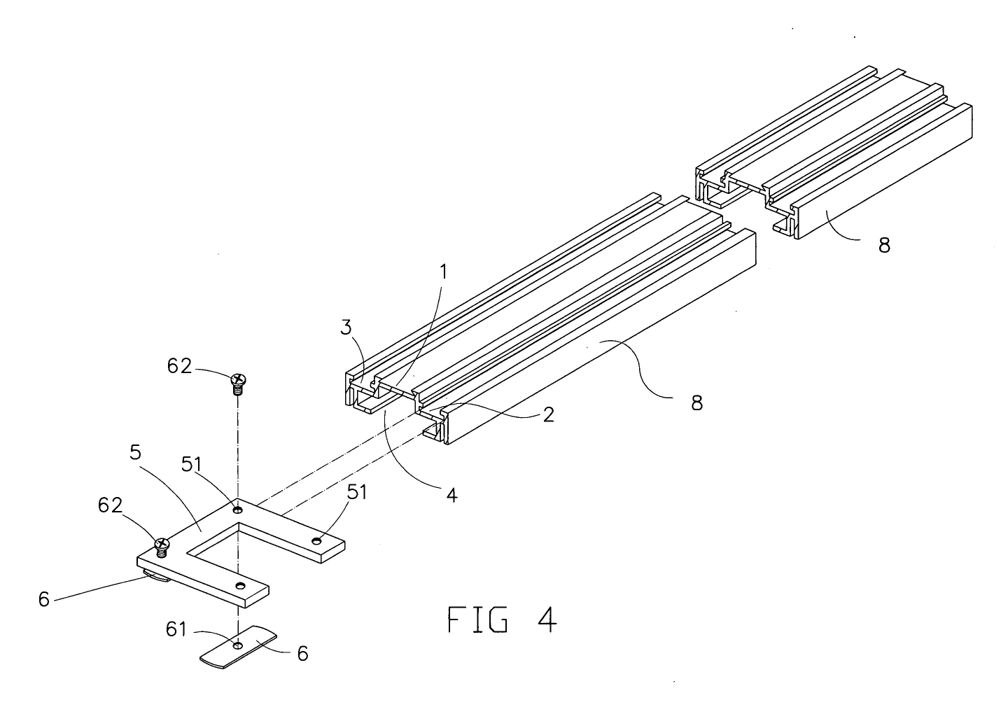

Please refer to FIGS. 3 and 4 at the same time. The base frames 8 are extruded bodies, each of which has a raised top central portion and a lowered wing portion at each lateral side of the raised top central portion. The raised top central portion of the base frame 8 is an open-topped upper channel in the form of a dovetail groove 1 having a predetermined depth. A scale 7 may be fitted in the dovetail groove 1. The two lowered lateral wing portions are formed into two symmetrically identical open-topped side channels 2, 3. And, a large-size open-bottomed lower channel 4 is formed below the upper channel 1 and the two side channels 2, 3. Each of the connecting brackets 5 is a U-shaped member having a thickness equal to a height difference between a top of the upper dovetail groove 1 and a top of the side channel 2, 3, and having a plurality of internally threaded through holes 51 provided at predetermined positions for screws 62 to thread thereinto. Each of the inserting plates 6 is a flat rectangular member having a predetermined thickness and provided at a predetermined position with an internally threaded through hole 61 for a screw 62 to thread thereinto. The rectangular inserting plate 6 has a width close to that of the side channels 2, 3 on the base frame 8 and can therefore be lengthwise inserted into the side channels 2, 3.

As can be seen from FIG. 3, each of the adjusting plates 10 is a flat and elongated rectangular member having a predetermined thickness, and being provided near an end with an internally threaded vertical through hole 101 for a screw 62 to thread thereinto. Each of the drill-locating seats 11 is a rectangular plate having a short sleeve 111 projected from a predetermined position on one surface of the seat 11 to define a hollow bore 112 for a bit (not shown) to extend therethrough. An internally threaded vertical through hole 113 is provided near one edge of the drill-locating seat 11 for a bolt 114 to extend thereinto via gaskets 115 and/or washers 116.

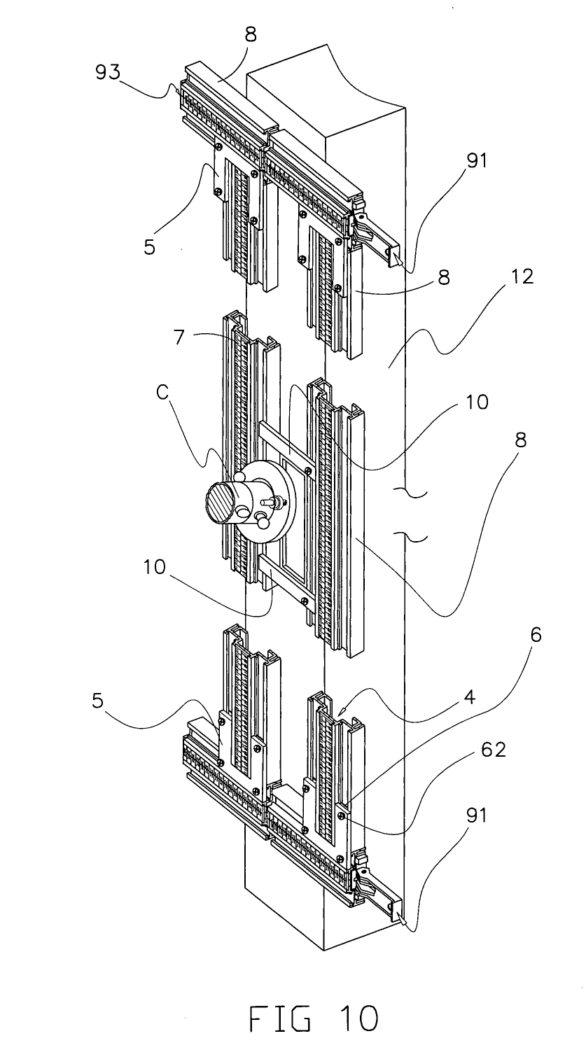

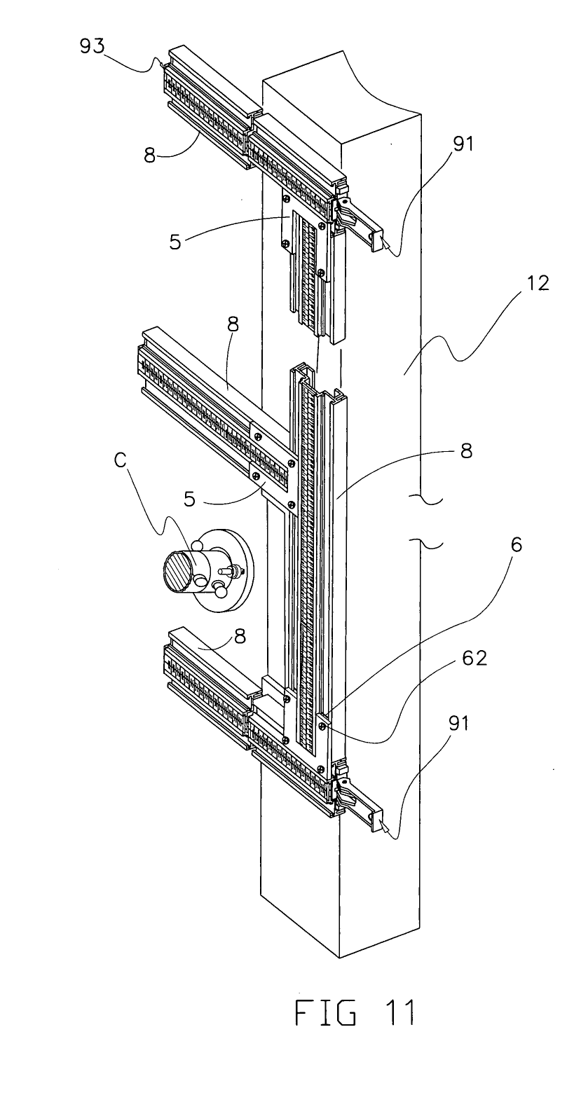

With the above arrangements, the inserting plates 6 may be connected to a lower side of the connecting brackets 5, the adjusting plates 10, and the drill-locating seat 11 by extending screws 62 and the bolt 114 through the threaded through holes 51, 101, and 113 on the connecting brackets 5, the adjusting plates 10, and the drill-locating seats 11, respectively, into the threaded holes 61 on the inserting plates 6. It is noted the connecting brackets 5, the adjusting plates 10, and the drill-locating seats 11 may be differently movably connected to the base frames 8 via the inserting plates 6 to enable active and flexible assembling of the base frames 8 to one another. For example, an assembly of one connecting bracket 5 and four inserting plates 6 may be associated with a first base frame 8 by lengthwise sliding two of the four inserting plates 6 below a crossbar portion of the U-shaped connecting bracket 5 into the side channel 2 or 3 on the first base frame 8, and another two inserting plates 6 below free ends of two leg portions of the U-shaped connecting bracket 5 into two side channels 2, 3 of a second base frame 8, as shown in FIGS. 3 and 7, so that the two base frames 8 are connected to each other at their adjacent edges at a right angle. Screws 62 may then be tightened against the connecting bracket 5 and the inserting plates 6 to firmly hold the inserting plates 6 in the side channels 2, 3 to thereby securely connect the two base frames 8 to one another. After the two base frames 8 are connected together in the above manner, a top surface of the connecting bracket 5 is flush with the top of the upper dovetail groove 1 to facilitate stable movement of a milling machine on the top of the connected base frames 8 (see FIGS. 10 and 11).

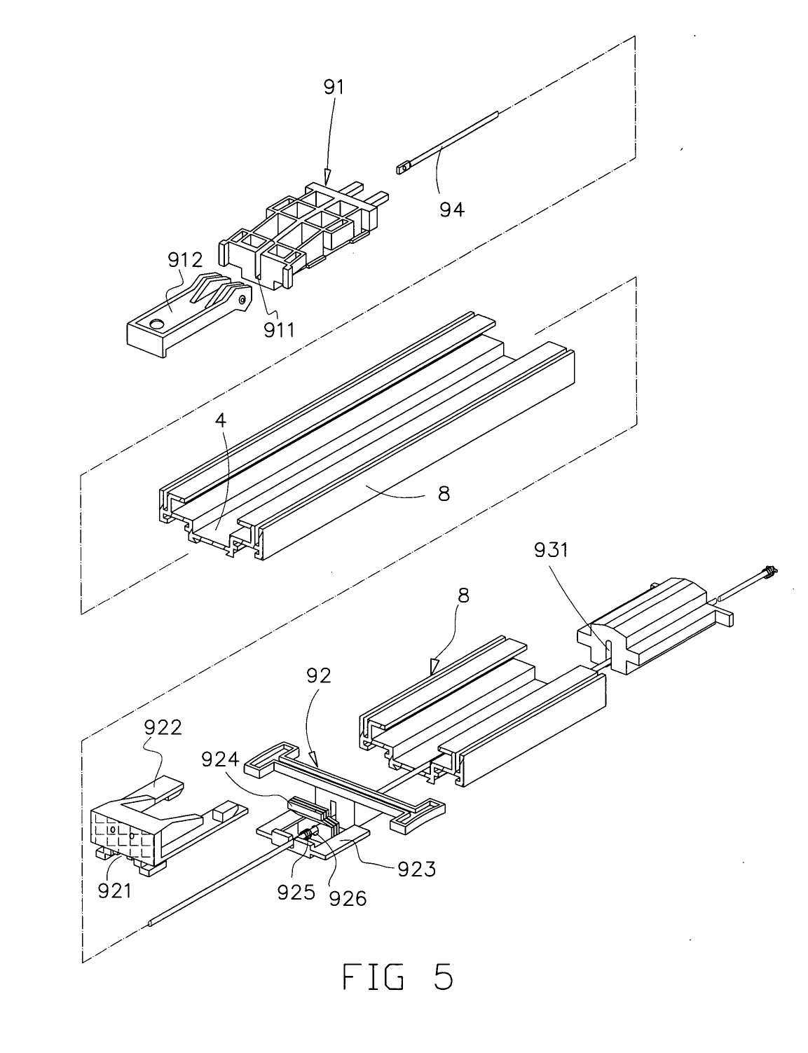

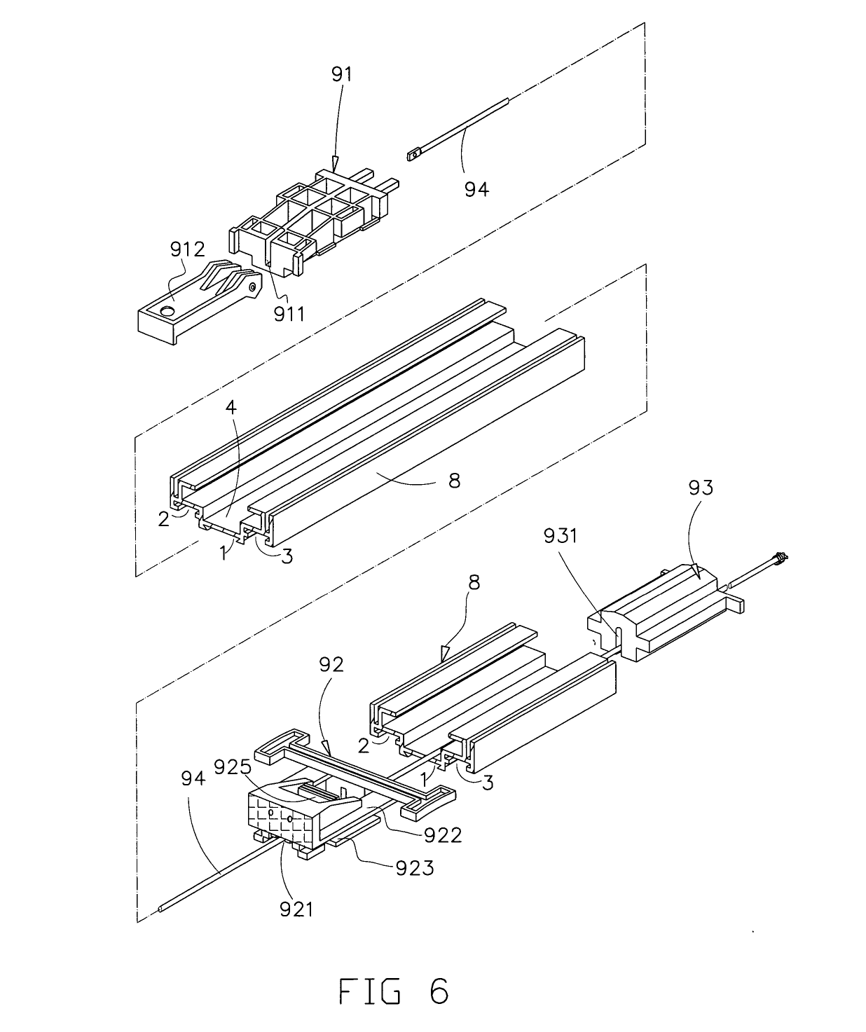

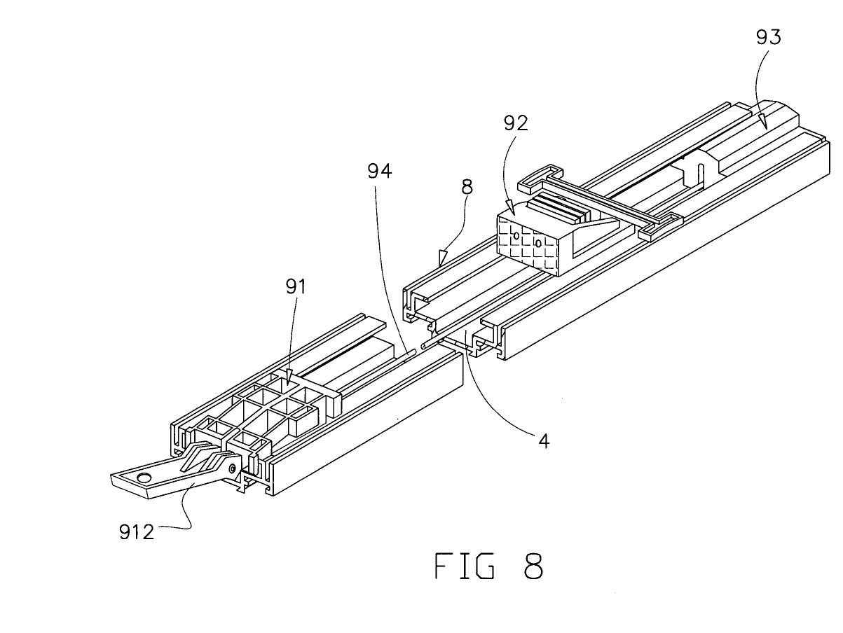

Please refer to FIGS. 5 and 6 in which a clamping device 9 included in the fixture assembly of the present invention is shown. The clamping device 9 includes three spaced parts, namely, a head part 91, a middle adjusting part 92, and a tail part 93, and a link 94. The head, the middle adjusting, and the tail part 91, 92, 93 are respectively provided at a predetermined position with a through hole 911, 921, 931 for the link 94 to extend therethrough before the clamping device 9 is connected to the lower channel 4 of the base frames 8. The head part 91 is fixedly mounted to a lower front end of a base frame 8 and includes a handle 912 pivotally connected to an outer (or front) end of the head part 91; the tail part 93 is fixedly mounted to a lower tail end of a linearly adjacent base frame 8; and the middle adjusting part 92 is mounted to the lower side of the base frame 8 at a position between the head and the tail part 91, 93, as can be most clearly seen from FIG. 8. The middle adjusting part 92 is assembled from an upper portion 922, a lower portion 923 having a plurality of bent metal sheets 924 with an opening 926 formed thereon for the link 94 to extend therethrough, and a compression spring 925 mounted around the link 94 in front of the opening 926 on the bent metal sheets 924 of the lower portion 923.

When the handle 912 of the head part 91 of the clamping device 9 is pivotally turned downward, the link 94 is synchronously pulled forward to cause the bent metal sheets 924 on the middle adjusting part 92 to push against the compression spring 925 and incline forward, so that the opening 926 on the bent metal sheets 924 is frictionally abutted against the link 94 to function like a brake. Reversely, when the handle 912 of the head part 91 of the clamping device 9 is released from the downward turned position, a restoring force of the previously compressed compression spring 925 returns the bent metal sheets 924 of the middle adjusting part 92 to their home position. Since the above-described operating manner of the clamping device 9 is known and has been widely employed in many other similar products, it is not discussed in further details herein.

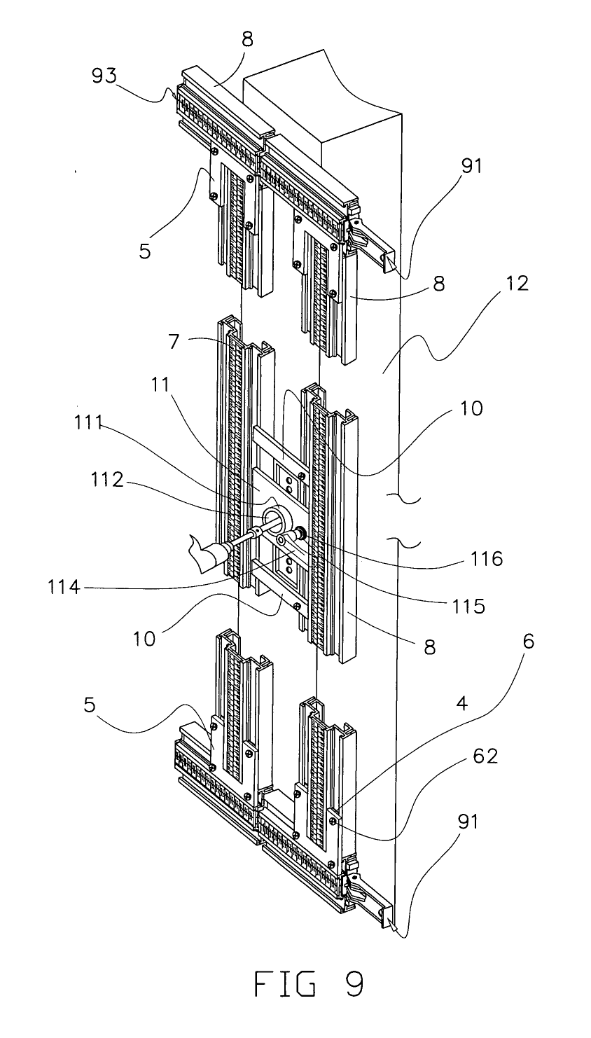

FIGS. 9 to 11 shows the use of the fixture assembly of the present invention in drilling and milling on woodwork. When the fixture assembly of the present invention is in a fully assembled state, it can be firmly fixed to a workpiece 12 using the clamping devices 9 connected to the lower channels 4 of the base frames 8. After the drill-locating seat 11 is adjusted to a desired position, it can be tightened against the base frame 8 using the bolt 114. And, a precise drilling work can be performed on the workpiece 12 now, as shown in FIG. 9. And, when it is desired to perform a groove-milling work on the workpiece 12, simply move and fix the adjusting plates 10 to a location within which the milling is to be performed, and bear a milling machine C against a top surface of the base frames 8 with a milling cutter below the milling machine C being restricted within the location defined by the adjusting plates 10, enabling a precise groove-milling work on the workpiece 12, as shown in FIG. 10. Since the fixture assembly of the present invention may be differently assembled, the base frames 8 can also be connected to form a shape as that shown in FIG. 11 to allow the milling machine C to conveniently mill an open recess on a workpiece 12, such as a door frame, for mounting a hinge thereto.

1. A fixture assembly for milling and drilling on woodwork, comprising a plurality of base frames, connecting brackets, adjusting plates, drill-locating seats, inserting plates, and clamping devices;
said base frames being extruded bodies, each of which has a raised top central portion and a lowered wing portion at each lateral side of said raised top central portion; said raised top central portion being an open-topped upper channel in the form of a dovetail groove having a predetermined depth, and said two lowered lateral wing portions being formed into two symmetrically identical open-topped side channels; and a large-size open-bottomed lower channel being formed below said upper dovetail groove and said two side channels;
each of said connecting brackets being a U-shaped member having a thickness equal to a height difference between a top of said upper dovetail groove and a top of said side channels, and having a plurality of internally threaded through holes provided at predetermined positions for screws to thread thereinto;
each of said adjusting plate being a flat and elongated rectangular member having a predetermined thickness, and provided near an end with an internally threaded vertical through hole for a screw to thread thereinto;
each of said drill-locating seats being a rectangular plate having a short sleeve projected from a predetermined position on one surface of said drill-locating seat to define a hollow bore;
each of the inserting plates being a flat rectangular member having a predetermined thickness, and said inserting plate having a width close to that of said side channels on said base frames, allowing said inserting plate to be lengthwise inserted into said side channels; and
each of said clamping devices including three spaced parts, namely, a head part, a middle adjusting part, and a tail part, and a link that is extended through said three spaced parts before said clamping device is connected to said lower channel of said base frame.

2. The fixture assembly for milling and drilling on woodwork as claimed in claim 1, wherein each of said drill-locating seats is provided near one edge with an internally threaded vertical through hole, into which a bolt is extended via gaskets and/or washers to secure said drill-locating seat to said base frames.

3. The fixture assembly for milling and drilling on woodwork as claimed in claim 1, wherein each of said inserting plates is provided at a predetermined position with an internally threaded through hole for a screw to thread thereinto and thereby secure said inserting plate to said base frames.

4. The fixture assembly for milling and drilling on woodwork as claimed in claim 1, wherein said inserting plates are connected to a lower side of said connecting brackets, said adjusting plates, and said drill-locating seats by extending screws or bolts through internally threaded through holes provided on said connecting brackets, said adjusting plates, and said drill-locating seats into threaded holes on said inserting plates.
